(19) United States
(12) Patent Application Publication
(10) Pub. No.: US 2026/0188746 A1
(43) Pub. Date: Jul. 2, 2026

(54) ELECTROLYTE FORMULATION FOR NICKEL-RICH CATHODE AND SILICON-RICH ANODE BATTERY CELLS

(71) Applicant: GM Global Technology Operations LLC, Detroit, MI (US)

(72) Inventors: Dewen Kong, Shanghai (CN); Haijing Liu, Shanghai (CN)

(21) Appl. No.: 19/033,850

(22) Filed: Jan. 22, 2025

(30) Foreign Application Priority Data
Dec. 27, 2024 (CN) 202411964519.1

(51) Int. Cl. H01M 10/0569; H01M 10/0567; H01M 10/0568

(52) U.S. Cl. CPC H01M 10/0569; H01M 10/0567; H01M 10/0568; H01M 2220/20; H01M 2300/004

(57) ABSTRACT

An electrolyte, a battery cell, and a vehicle with a vehicle battery is provided. The electrolyte includes a ternary salt, dual-cyclic solvents, a linear carbonate solvent, and quaternary additives. The ternary salt includes lithium hexafluorophosphate (LiPF₆), lithium bis(fluorosulfonyl)imide (LiFSI), and lithium difluoro(oxalate)borate (LiDFOB). The dual-cyclic solvents include ethylene carbonate (EC) between 0-30% by volume and fluoroethylene carbonate (FEC) between 0-30% by volume. The linear carbonate solvent includes at least one of ethyl methyl carbonate (EMC), dimethyl carbonate (DMC), or diethyl carbonate (DEC). The linear carbonate solvent is between 60-80% by volume. The quaternary additives include vinylene carbonate (VC) between 0.5-2% by weight, trimethylsilyl (TMSi) between 0.25-1% by weight, bis(2,2,2-trifluoroethyl) carbonate (DFDEC) between 0.5-2% by weight, and succinic anhydride (SA) between 0.25-1% by weight.

### INTRODUCTION

The present disclosure relates to a vehicle battery pack and battery cells, and more particularly, to an electrolyte for a lithium ion battery cell within the battery pack.

Electric and hybrid electric vehicle technology is enabled by the development and deployment of rechargeable, secondary batteries, which provide energy to the vehicle powertrain. Secondary batteries include lithium ion batteries, which generally include a cathode, anode, separator, and electrolyte. The cathode provides a source of lithium ions and determines capacity and average voltage of a battery. The anode stores and releases lithium ions received from the cathode when energy is needed. The separator prevents the cathode and anode from contacting and shorting out the battery, and the electrolyte provides a medium between the cathode and anode through which the lithium ions travel. Energy density, or areal capacity, of the secondary battery may be increased by adding more cathode and anode active material and increasing the density of the cathode and anode. At elevated temperatures, the anode may swell during cycling and the cathode may experience structural collapse. Degradation of the cathode, anode, and electrolyte can lead to rapidly reduced capacity, lower efficiency, and shorter battery life.

Thus, while present lithium battery cell chemistries achieve their intended purpose, there is a need for new and improved chemistries that offer improved electrochemical performance and cycle life while maintaining ultrafast chargeable capacity.

### SUMMARY

According to several aspects of the present disclosure, an electrolyte for a battery cell having a nickel-rich cathode and a silicon-rich anode is provided. The electrolyte includes a ternary salt, dual-cyclic solvents, a linear carbonate solvent, and quaternary additives. The ternary salt includes lithium hexafluorophosphate (LiPF₆) having a concentration between 0.5-1.2 molar (M) to provide lithium conductivity, lithium bis(fluorosulfonyl)imide (LiFSI) having a concentration between 0.1-0.3 molar (M) to provide lithium conductivity, and lithium difluoro(oxalate)borate (LiDFOB) having a concentration between 0.1-0.3 molar (M) to form a cathode-electrolyte interphase (CEI) on the nickel-rich cathode. The dual-cyclic solvents include ethylene carbonate (EC) between 0-30% by volume to form a solid electrolyte interphase (SEI) on the silicon-rich anode and fluoroethylene carbonate (FEC) between 0-30% by volume to form the solid electrolyte interphase (SEI) on the silicon-rich anode. The linear carbonate solvent includes at least one of ethyl methyl carbonate (EMC), dimethyl carbonate (DMC), or diethyl carbonate (DEC). The linear carbonate solvent is between 60-80% by volume to enhance solubility of the ternary salts. The quaternary additives include vinylene carbonate (VC) between 0.5-2% by weight to form the solid electrolyte interphase (SEI) on the silicon-rich anode, trimethylsilyl (TMSi) between 0.25-1% by weight to form the cathode-electrolyte interphase (CEI) on the nickel-rich cathode, bis(2,2,2-trifluoroethyl) carbonate (DFDEC) between 0.5-2% by weight to form the solid electrolyte interphase (SEI) on the silicon-rich anode, and succinic anhydride (SA) between 0.25-1% by weight to form a cathode-electrolyte interphase (CEI) on the nickel-rich cathode.

In accordance with another aspect of the disclosure, the lithium hexafluorophosphate (LiPF₆) has a concentration of about 0.8M.

In accordance with another aspect of the disclosure, the lithium bis(fluorosulfonyl)imide (LiFSI) has a concentration of about 0.2M.

In accordance with another aspect of the disclosure, the lithium difluoro(oxalate)borate (LiDFOB) has a concentration of about 0.2 M.

In accordance with another aspect of the disclosure, the ethylene carbonate (EC) is about 20% by volume.

In accordance with another aspect of the disclosure, the fluoroethylene carbonate (FEC) is about 10% by volume.

In accordance with another aspect of the disclosure, the ethyl methyl carbonate (EMC) is about 70% by volume.

In accordance with another aspect of the disclosure, the vinylene carbonate (VC) is about 0.5% by weight.

In accordance with another aspect of the disclosure, the trimethylsilyl (TMSi) is about 0.5% by weight.

In accordance with another aspect of the disclosure, the bis(2,2,2-trifluoroethyl) carbonate (DFDEC) is about 1% by weight.

In accordance with another aspect of the disclosure, the succinic anhydride (SA) is about 0.5% by weight.

In accordance with another aspect of the disclosure, the nickel-rich cathode is formed from nickel cobalt manganese aluminum (NCMA) having a capacity of 3.7 ampere-hours (Ah).

In accordance with another aspect of the disclosure, the nickel-rich cathode includes at least one of LiNiO₂ (LNO), nickel cobalt manganese (NCM), nickel cobalt aluminum (NCA), or lithium manganese iron phosphate (LMFP)/nickel cobalt manganese aluminum (NCMA).

In accordance with another aspect of the disclosure, the nickel-rich cathode has a nickel content greater than or equal to 60% by weight.

In accordance with another aspect of the disclosure, the silicon-rich anode includes silicon between 10-60% by weight.

In accordance with another aspect of the disclosure, the silicon-rich anode is greater than or equal to 40% by weight silicon.

In accordance with another aspect of the disclosure, the silicon-rich anode has an electrode loading between 3-8 milliampere-hours per square centimeter (mAh/cm²).

According to several aspects of the present disclosure, a battery cell for a vehicle battery pack is provided. The battery cell includes a nickel-rich cathode, a silicon-rich anode, and an electrolyte to provide a medium between the nickel-rich cathode and the silicon-rich anode through which lithium ions travel. The electrolyte includes a ternary salt, dual-cyclic solvents, a linear carbonate solvent, and quaternary additives. The ternary salt includes lithium hexafluorophosphate (LiPF₆) having a concentration between 0.5-1.2 molar (M) to provide lithium conductivity, lithium bis(fluorosulfonyl)imide (LiFSI) having a concentration between 0.1-0.3 molar (M) to provide lithium conductivity, and lithium difluoro(oxalate)borate (LiDFOB) having a concentration between 0.1-0.3 molar (M) to form a cathode-electrolyte interphase (CEI) on the nickel-rich cathode. The dual-cyclic solvents include ethylene carbonate (EC) between 0-30% by volume to form a solid electrolyte interphase (SEI) on the silicon-rich anode and fluoroethylene carbonate (FEC) between 0-30% by volume to form the solid electrolyte interphase (SEI) on the silicon-rich anode. The linear carbonate solvent includes at least one of ethyl methyl carbonate (EMC), dimethyl carbonate (DMC), or diethyl carbonate (DEC). The linear carbonate solvent is between 60-80% by volume to enhance solubility of the ternary salts. The quaternary additives include vinylene carbonate (VC) between 0.5-2% by weight to form the solid electrolyte interphase (SEI) on the silicon-rich anode, trimethylsilyl (TMSi) between 0.25-1% by weight to form the cathode-electrolyte interphase (CEI) on the nickel-rich cathode, bis(2,2,2-trifluoroethyl) carbonate (DFDEC) between 0.5-2% by weight to form the solid electrolyte interphase (SEI) on the silicon-rich anode, and succinic anhydride (SA) between 0.25-1% by weight to form a cathode-electrolyte interphase (CEI) on the nickel-rich cathode.

In accordance with another aspect of the disclosure, the battery cell is at least one of a prismatic cell, a pouch cell, or a cylindrical cell.

According to several aspects of the present disclosure, a vehicle having a vehicle battery is provided. The vehicle includes a vehicle battery pack including a plurality of battery cells. The battery cell includes a nickel-rich cathode, a silicon-rich anode, and an electrolyte to provide a medium between the nickel-rich cathode and the silicon-rich anode through which lithium ions travel. The electrolyte includes a ternary salt, dual-cyclic solvents, a linear carbonate solvent, and quaternary additives. The ternary salt includes lithium hexafluorophosphate (LiPF₆) having a concentration between 0.5-1.2 molar (M) to provide lithium conductivity, lithium bis(fluorosulfonyl)imide (LiFSI) having a concentration between 0.1-0.3 molar (M) to provide lithium conductivity, and lithium difluoro(oxalate)borate (LiDFOB) having a concentration between 0.1-0.3 molar (M) to form a cathode-electrolyte interphase (CEI) on the nickel-rich cathode. The dual-cyclic solvents include ethylene carbonate (EC) between 0-30% by volume to form a solid electrolyte interphase (SEI) on the silicon-rich anode and fluoroethylene carbonate (FEC) between 0-30% by volume to form the solid electrolyte interphase (SEI) on the silicon-rich anode. The linear carbonate solvent includes at least one of ethyl methyl carbonate (EMC), dimethyl carbonate (DMC), or diethyl carbonate (DEC). The linear carbonate solvent is between 60-80% by volume to enhance solubility of the ternary salts. The quaternary additives include vinylene carbonate (VC) between 0.5-2% by weight to form the solid electrolyte interphase (SEI) on the silicon-rich anode, trimethylsilyl (TMSi) between 0.25-1% by weight to form the cathode-electrolyte interphase (CEI) on the nickel-rich cathode, bis(2,2,2-trifluoroethyl) carbonate (DFDEC) between 0.5-2% by weight to form the solid electrolyte interphase (SEI) on the silicon-rich anode, and succinic anhydride (SA) between 0.25-1% by weight to form a cathode-electrolyte interphase (CEI) on the nickel-rich cathode.

The above features and advantages, and other features and advantages, of the presently disclosed system and method are readily apparent from the detailed description, including the claims, and examples when taken in connection with the accompanying drawings.

### BRIEF DESCRIPTION OF THE DRAWINGS

The present disclosure will become more fully understood from the detailed description and the accompanying drawings.

FIG. 1 is a perspective view illustrating an example of a vehicle having an electric motor powered by a battery pack having a nickel-rich cathode, a silicon-rich anode, and an electrolyte, in accordance with the present disclosure.

FIG. 2 is a cross section schematic view of a battery cell in the battery pack in the vehicle shown in FIG. 1, where the battery cell includes a nickel-rich cathode, a silicon-rich anode, and an electrolyte, in accordance with the present disclosure.

### DETAILED DESCRIPTION

The following description is merely exemplary in nature and is not intended to limit the present disclosure, application, or uses. Furthermore, there is no intention to be bound by any expressed or implied theory presented in the preceding introduction, summary, or the following detailed description. It should be understood that throughout the drawings, corresponding reference numerals indicate like or corresponding parts and features.

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale. The following description is merely exemplary in nature and is not intended to limit the present disclosure, application, or uses.

Nickel-rich silicon containing battery cells provide high energy density, which is promising in the electric vehicle battery market. However, some challenges include anode swelling during cycling and cathode structural collapse at elevated temperatures. These issues often cause rapid capacity fading, especially when silicon content is high (e.g., greater than 30% on the anode side). The electrolyte and battery cell disclosed herein improve cycle life and calendar life while maintaining ultrafast charging capability of nickel-rich cathode and silicon-rich anode battery cells. The electrolyte and battery cells disclosed herein also work to construct a uniform and robust cathode electrolyte interface (CEI) on the nickel-rich cathode and a flexible, robust, and adaptive solid electrolyte interface (SEI) on the silicon-rich anode.

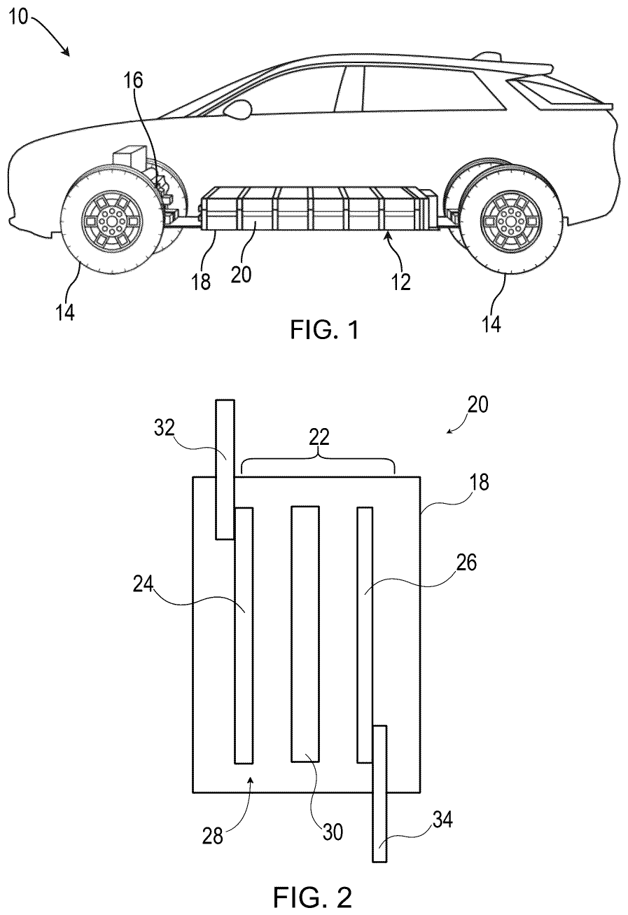

Referring to FIG. 1, a perspective view of a vehicle 10 having a vehicle battery pack 12 is illustrated, in accordance with the present disclosure. The battery pack 12 is illustrated with an exemplary vehicle 10. The vehicle 10 is an electric vehicle or hybrid vehicle having wheels 14 driven by at least one electric motor/inverter 16. The electric motors/inverters 16 receive power from the battery pack 12. While the vehicle 10 is illustrated as a passenger road vehicle, it should be appreciated that the battery pack 12 may be used with various other types of vehicles. For example, the battery pack 12 may be used in nautical vehicles, such as boats, or aeronautical vehicles, such as drones or passenger airplanes. Moreover, the battery pack 12 may be used as a stationary power source separate and independent from a vehicle. Battery pack 12 includes a housing 18 for carrying and supporting a plurality of battery cells 20. In an example, the battery pack 12 may have fifty or more battery cells 20.

As used herein, the term “vehicle” is not limited to automobiles. While the present technology is described primarily herein in connection with electric and hybrid-electric vehicles, the technology is not limited to electric and hybrid-electric vehicles. The concepts can be used in a wide variety of applications, such as in connection with components used in motorcycles, mopeds, locomotives, aircraft, marine craft, and other vehicles, as well as in other applications utilizing batteries, such as in portable power stations, such as those used for powering remote job sites, emergency back-up power supplies, and permanent power stations associated with buildings and equipment, all of which may be powered by, for example, solar or wind-powered generator systems, power mains, and fuel based power generators such as gasoline, propane, kerosene, or diesel generators as well as sterling engines.

FIG. 2 illustrates one battery cell 20 within the battery pack 12 illustrated in FIG. 1. The battery pack 12 and the battery cells 20 will be understood to be rechargeable batteries that may be discharged upon application of a load and recharged upon the application of an external power source. While the battery cells 20 are shown as prismatic-type battery cells, the battery cells 20 may also include, for example, pouch-style cells and/or cylindrical-style cells.

Each battery cell 20 disposed within the battery pack 12 shown in FIG. 1 has a housing 18 (or case or container) and at least one electrode stack 22, which further includes a cathode 24, an anode 26, an electrolyte 28, and/or a separator 30. Each battery cell 20 may have tens or hundreds of electrode stacks 22. Each electrode stack 22 is connected to a current collector 32, 34. The electrode stacks are placed in the housing 18, which are filled with an electrolyte 28. The electrolyte 28 transports ions between the cathode 24 and the anode 26. The current collectors 32, 34 are thin metal plates or foils disposed on sides of the electrode stacks 22 and/or housing 18 and typically have a thickness between 0.001 and 1 millimeter. The current collectors 32, 34 may be made of copper (e.g., 6 μm foil) or aluminum (e.g., 12 μm foil) and are attached to the electrode stacks 22 to transmit the electric current to an external circuit (not shown).

During discharge, when a load is applied to the battery cells 20, Li⁺ ions move from the anode 26 to the cathode 24 through the separator 30 by way of the electrolyte 28. Equivalent electrons e³¹ move through battery circuitry from the cathode 24 to the anode 26, providing energy to a battery load. While charging and upon application of an external voltage, Li⁺ ions move from the cathode 24 to the anode 26 by way of the electrolyte 28 through the separator 30 and may be intercalated into the anode 26.

Each battery cell 20, such as that illustrated in FIG. 2, generally includes the cathode 24 disposed on a cathode current collector 32, the anode 26 disposed on an anode current collector 34, the separator 30 positioned between the cathode 24 and the anode 26, and the electrolyte 28. While the illustrated battery cells 20 show one anode 26 (and anode current collector 34) and one cathode 24 (and one cathode current collector 32), the battery cell 20 may alternatively include two or more cathodes 24 (and cathode current collectors 32) and one or more anodes 26 (and anode current collectors 34). In any of the designs above, one or more separators 30 are interleaved between the cathodes 24 and anodes 26 to prevent the cathodes 24 and the anodes 26 from contacting.

In the styles of battery cells 20 noted above, the cathode current collector 32 and anode current collector 34 are formed from conductive materials. In embodiments, the cathode current collector 32 includes aluminum. Alternatively, or additionally, the cathode current collector 32 may include copper clad aluminum and/or stainless steel. The anode current collector 34 may include one or more of copper, nickel, stainless steel, or titanium. The current collectors 32, 34 are illustrated as being in the form of a foil; however, it should be appreciated that other forms may be exhibited such as mesh, wire, or a composite-type material. In embodiments, the foil cathode current collector 32 and the foil anode current collector 34 are impermeable to gas. The cathode current collector 32 may exhibit a thickness in the range of 5 micrometers to 50 micrometers including all values and ranges therein, for example in the range of 5 micrometers to 25 micrometers. The anode current collector 34 may exhibit a thickness in the range of 5 micrometers to 50 micrometers including all values and ranges therein, for example in the range of 5 micrometers to 25 micrometers.

The cathode 24 includes a cathode active material that provides a source of lithium ions (Li⁺) and can undergo reversible insertion or intercalation of lithium ions determining, for example, the capacity and average voltage of a battery. In general, the cathode 24 can be nickel-rich (e.g., greater than or equal to 60% by weight nickel). In embodiments, the cathode active material includes lithium manganese iron phosphate (LMFP) and/or lithium nickel cobalt manganese aluminum oxide (NCMA). The cathode active material may include lithium manganese iron phosphate (LMFP) because LMFP batteries are known for their thermal stability and safety, because iron and manganese, which are more abundant and less expensive that other materials, such as nickel and cobalt, can lower the overall cost of batteries, and because LMFP batteries offer good energy density and long life cycle. The cathode active material may include lithium nickel cobalt manganese aluminum oxide (NCMA) because NCMA batteries have a high nickel content, which increases energy density, because NCMA reduces reliance on cobalt, which may be expensive, and because addition of aluminum enhances thermal stability and overall battery safety. The cathode active material may also include LiNiO₂ (LNO), nickel cobalt manganese (NCM), and/or nickel cobalt aluminum (NCA). In one example, the nickel-rich cathode is formed from nickel cobalt manganese aluminum (NCMA) having a capacity of 3.7 ampere-hours (Ah).

The anode 26 includes materials that can undergo reversible insertion or intercalation of lithium ions at a lower electrochemical potential than the cathode 24 material such that an electrochemical potential difference exists between the anode 26 and cathode 24. In an example, the anode 26 includes silicon between 10-60% by weight, and more preferably, the anode 26 is greater than or equal to 40% by weight silicon. The anode 26 may include one or more of lithium metal; alloys of lithium for example lithium silicon alloy, lithium aluminum alloy, lithium indium alloy, lithium titanate, and lithium tin alloy; carbon based materials for example graphite, activated carbon, carbon black and graphene; silicon; silicon based alloys; silicon oxide; silicon based composite materials; tin oxide; aluminum; indium; zinc; germanium; and titanium oxide; as well as any combination of the above. In embodiments, the anode 26 may exhibit a thickness in the range of 50 micrometers to 150 micrometers including all values and ranges therein. In a specific example, the anode 26 is silicon-rich and has an electrode loading between 3-8 milliampere-hours per square centimeter (mAh/cm²). The combined anode 26 and anode current collector 34 provide an anode electrode.

The anode 26 includes an active anode material. The active anode material can include an artificial-type graphite (AG graphite) and/or a natural-type graphite (NG graphite), at least one binder, and/or at least one carbon additive. AG graphite, also known as synthetic graphite, includes a man-made form of carbon that is produced through high-temperature treatment of carbon materials like petroleum coke and coal tar pitch. NG graphite may include a naturally occurring form of crystalline carbon found in metamorphic and igneous rocks.

The separator 30 includes a porous material formed of an electrically insulative material that prevents the cathode 24 and the anode 26 from contacting and potentially shortening out the battery circuit. The separator 30 is sandwiched, or at least partially enclosed, between the cathode 24 and anode 26 allowing the passage of the lithium ions and electrolyte 28 through the pores of the separator 30. The separator 30 may include one or more of a composite material, a polymeric material, or a non-woven material. In embodiments, the separator 30 includes at least one of polyethylene, polypropylene, polyamide, polytetrafluoroethylene, polyvinylidene fluoride, and polyvinyl chloride. In addition, the separator 30 may be filled, i.e., include fillers dispersed therein, wherein the filler includes a material, for example glass fiber. In additional or alternative embodiments, the separator 30 may include at least one of a thermally stable, porous polymer coating and a ceramic coating, for example an alumina coating. The coating may be disposed on one or more surfaces of a porous polymer film, where the polymer film may be selected from at least one of polyethylene and polypropylene. The separator 30 may include one or more layers, wherein each layer is formed from one or more of the materials noted above. The separator 30 may take the form of film or a mesh, such as woven mesh or a slit film. It will be understood that the separator 30 may include other various configurations of layers and/or coatings.

The electrolyte 28 provides a medium between the cathode 24 and anode 26 through which lithium ions and the electrolyte 28 travel. The medium may be a liquid, gel, or solid, and may be capable of conducting the lithium ions between the cathode 24 and the anode 26. The electrolyte 28 permeates the pores of the porous separator 30 and wets, or otherwise contacts, the surfaces of the cathode 24 and anode 26 as well as the separator 30.

In embodiments, the electrolyte 28 includes one or more lithium salts dissolved in non-aqueous organic solvent. The lithium salts may include one or more of the following: lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiBOB or “LSO”) (LiB(C₂O₄)₂), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl) imide (LiN(F_{S}O₂)₂) (LiSFI), lithium (triethylene glycol dimethy 1 ether)bis(trifluoromethanesulfonyl)imide (Li(G₃)(TFSI), and/or lithium bis(trifluoromethanesulfonyl)azanide (LiTFSA). The lithium salt may be present in the electrolyte 28 at a concentration (moles of salt per liter of solvent (M)) ranging from 0.5M to 2.16M, including all values and ranges therein, for example 1M or 2M. The electrolyte may include a solvent (e.g., carbonate ester) and may include one or more additives (e.g., fluoroethylene carbonate (FEC), vinylene carbonate (VC), 1,3,2-dioxathiolane 2,2-dioxide (DTD), tris(trimethylsilyl) phosphite (TMSPi), lithium difluoro(oxalate)borate (LiDFOB), tris(trimethylsilyl) borate (TMSPB), and the like).

The electrolyte 28 may additionally include one or more of various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1,2-diethoxyethane, ethoxymethoxy ethane), and/or cyclic ethers (e.g., tetrahydrofuran, 2-methyltetrahydrofuran) , 1,3-dioxolane).

Further, the electrolyte 28 may include a number of additives, such as, but not limited to vinyl-ethylene carbonate (VEC), propane sulfonate, lithium difluorophosphate (LiPF₂O₂), and/or combinations thereof. Other additives may include diluents which do not coordinate with lithium ions but can reduce viscosity of the electrolyte 28, for example bis(2,2,2-trifluoroethyl) ether (BTFE), and/or flame retardants, for example triethyl phosphate.

In an example, the electrolyte 28 includes ternary salts when used with a nickel-rich cathode 24 and a silicon-rich anode 26. In this example, the ternary salts include lithium hexafluorophosphate (LiPF₆), lithium bis(fluorosulfonyl)imide (LiFSI), and lithium difluoro(oxalate)borate (LiDFOB). The lithium hexafluorophosphate (LiPF₆) can include a concentration between about 0.5-1.2 molar (M), preferably about 0.8M, and functions to provide lithium conductivity. The lithium bis(fluorosulfonyl)imide (LiFSI) can include a concentration between about 0.1-0.3 molar (M), preferably about 0.2M, and functions to provide lithium conductivity. The lithium difluoro(oxalate)borate (LiDFOB) can have a concentration between about 0.1-0.3 molar (M), preferably about 0.2M, and functions to form a cathode-electrolyte interphase (CEI) on the nickel-rich cathode. The term “about” will be understood by one of skill in the art. Alternatively, the term “about” will be understood to mean plus or minus 0.1 M.

Continuing with the example, the electrolyte 28 includes dual-cyclic solvents. The dual-cyclic solvents include ethylene carbonate (EC) and fluoroethylene carbonate (FEC). The ethylene carbonate (EC) can be between 0-30% by volume, preferably about 20% by volume. The fluoroethylene carbonate (FEC) can be between 0-30% by volume, preferably about 10% by volume. The term “about” will be understood by one of skill in the art. Alternatively, the term “about” will be understood to mean plus or minus 1% by volume. The ethylene carbonate (EC) and the fluoroethylene carbonate (FEC) function to form the solid electrolyte interphase (SEI) on the silicon-rich anode 26.

Continuing with the example, the electrolyte 28 includes a linear carbonate solvent including at least one of ethyl methyl carbonate (EMC), dimethyl carbonate (DMC), or diethyl carbonate (DEC). The linear carbonate solvent can be between 60-80% by volume of the electrolyte 28, preferably about 70% by volume. The term “about” will be understood by one of skill in the art. Alternatively, the term “about” will be understood to mean plus or minus 1% by volume. The linear carbonate solvent serves to enhance solubility of the ternary salts.

Continuing with this example, the electrolyte 28 includes quaternary additives. The quaternary additives can include vinylene carbonate (VC), trimethylsilyl (TMSi), bis(2,2,2-trifluoroethyl) carbonate (DFDEC), and succinic anhydride (SA). The vinylene carbonate (VC) can be between 0.5-2% by weight of the electrolyte 28, preferably about 0.5% by weight (if the LiBOB is greater than 30%). The vinylene carbonate (VC) serves to form the solid electrolyte interphase (SEI) on the silicon-rich anode. The trimethylsilyl (TMSi) can be between 0.25-1% by weight, and more preferably about 0.5% by weight. The trimethylsilyl (TMSi) serves to form the cathode-electrolyte interphase (CEI) on the nickel-rich cathode. The bis(2,2,2-trifluoroethyl) carbonate (DFDEC) can be between 0.5-2% by weight, and more preferably about 1% by weight. The bis(2,2,2-trifluoroethyl) carbonate (DFDEC) serves to form the solid electrolyte interphase (SEI) on the silicon-rich anode. The succinic anhydride (SA) can be between 0.25-1% by weight, and more preferably about 0.5% by weight. The succinic anhydride (SA) serves to form a cathode-electrolyte interphase (CEI) on the nickel-rich cathode. The term “about” will be understood by one of skill in the art. Alternatively, the term “about” will be understood to mean plus or minus 0.1% by weight.

In a specific example, the electrolyte 28 includes ternary salts comprising LiPF₆ having a concentration of 0.8M, LiFSi having a concentration of 0.2M, and LiDFOB having a concentration of 0.1M, a solvent comprising EC/FEC/EMC having a ratio of 2:1:7 by volume of the solvent, and additives comprising 0.5% by weight VC, 0.5% by weight TMSi, 1% by weight of DFDEC, and 0.5% by weight SA. It will be appreciated that the electrolyte 28 may include various other components and amounts/concentrations of components.

The electrolyte 28 and battery cell 20 of the present disclosure is advantageous and beneficial over the prior art. The electrolyte 28 and battery cell 20 improve cycle life and calendar life while maintaining ultrafast charging capability of nickel-rich cathode and silicon-rich anode battery cells. The electrolyte and battery cells also work to construct a uniform and robust cathode electrolyte interface (CEI) on the nickel-rich cathode and a flexible, robust, and adaptive solid electrolyte interface (SEI) on the silicon-rich anode.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. An electrolyte for a battery cell having a nickel-rich cathode and a silicon-rich anode, comprising:
a ternary salt including
lithium hexafluorophosphate (LiPF₆) having a concentration between 0.5-1.2 molar (M) to provide lithium conductivity;
lithium bis(fluorosulfonyl)imide (LiFSI) having a concentration between 0.1-0.3 molar (M) to provide lithium conductivity; and
lithium difluoro(oxalate)borate (LiDFOB) having a concentration between 0.1-0.3 molar (M) to form a cathode-electrolyte interphase (CEI) on the nickel-rich cathode;
dual-cyclic solvents including
ethylene carbonate (EC) between 0-30% by volume to form a solid electrolyte interphase (SEI) on the silicon-rich anode; and
fluoroethylene carbonate (FEC) between 0-30% by volume to form the solid electrolyte interphase (SEI) on the silicon-rich anode;
a linear carbonate solvent including at least one of
ethyl methyl carbonate (EMC);
dimethyl carbonate (DMC); or
diethyl carbonate (DEC), where the linear carbonate solvent is between 60-80% by volume to enhance solubility of the ternary salts; and
quaternary additives including
vinylene carbonate (VC) between 0.5-2% by weight to form the solid electrolyte interphase (SEI) on the silicon-rich anode;
trimethylsilyl (TMSi) between 0.25-1% by weight to form the cathode-electrolyte interphase (CEI) on the nickel-rich cathode;
bis(2,2,2-trifluoroethyl) carbonate (DFDEC) between 0.5-2% by weight to form the solid electrolyte interphase (SEI) on the silicon-rich anode; and
succinic anhydride (SA) between 0.25-1% by weight to form a cathode-electrolyte interphase (CEI) on the nickel-rich cathode.

2. The electrolyte in claim 1, wherein the lithium hexafluorophosphate (LiPF₆) has a concentration of about 0.8M.

3. The electrolyte in claim 1, wherein the lithium bis(fluorosulfonyl)imide (LiFSI) has a concentration of about 0.2M.

4. The electrolyte in claim 1, wherein the lithium difluoro(oxalate)borate (LiDFOB) has a concentration of about 0.2 M.

5. The electrolyte in claim 1, wherein the ethylene carbonate (EC) is about 20% by volume.

6. The electrolyte in claim 1, wherein the fluoroethylene carbonate (FEC) is about 10% by volume.

7. The electrolyte in claim 1, wherein the ethyl methyl carbonate (EMC) is about 70% by volume.

8. The electrolyte in claim 1, wherein the vinylene carbonate (VC) is about 0.5% by weight.

9. The electrolyte in claim 1, wherein the trimethylsilyl (TMSi) is about 0.5% by weight.

10. The electrolyte in claim 1, wherein the bis(2,2,2-trifluoroethyl) carbonate (DFDEC) is about 1% by weight.

11. The electrolyte in claim 1, wherein the succinic anhydride (SA) is about 0.5% by weight.

12. The electrolyte in claim 1, wherein the nickel-rich cathode is formed from nickel cobalt manganese aluminum (NCMA) having a capacity of 3.7 ampere-hours (Ah).

13. The electrolyte in claim 1, wherein the nickel-rich cathode includes at least one of LiNiO₂ (LNO), nickel cobalt manganese (NCM), nickel cobalt aluminum (NCA), or lithium manganese iron phosphate (LMFP)/nickel cobalt manganese aluminum (NCMA).

14. The electrolyte in claim 1, wherein the nickel-rich cathode has a nickel content greater than or equal to 60% by weight.

15. The electrolyte in claim 1, wherein the silicon-rich anode includes silicon between 10-60% by weight.

16. The electrolyte in claim 1, wherein the silicon-rich anode is greater than or equal to 40% by weight silicon.

17. The electrolyte in claim 1, wherein the silicon-rich anode has an electrode loading between 3-8 milliampere-hours per square centimeter (mAh/cm²).

18. A battery cell for a vehicle battery pack, comprising:
a nickel-rich cathode;
a silicon-rich anode; and
an electrolyte to provide a medium between the nickel-rich cathode and the silicon-rich anode through which lithium ions travel, the electrolyte including
a ternary salt including
lithium hexafluorophosphate (LiPF₆) having a concentration between 0.5-1.2 molar (M) to provide lithium conductivity;
lithium bis(fluorosulfonyl)imide (LiFSI) having a concentration between 0.1-0.3 molar (M) to provide lithium conductivity; and
lithium difluoro(oxalate)borate (LiDFOB) having a concentration between 0.1-0.3 molar (M) to form a cathode-electrolyte interphase (CEI) on the nickel-rich cathode;
dual-cyclic solvents including
ethylene carbonate (EC) between 0-30% by volume to form a solid electrolyte interphase (SEI) on the silicon-rich anode; and
fluoroethylene carbonate (FEC) between 0-30% by volume to form the solid electrolyte interphase (SEI) on the silicon-rich anode;
a linear carbonate solvent including
ethyl methyl carbonate (EMC) between 60-80% by volume to enhance solubility of the ternary salts; and
quaternary additives including
vinylene carbonate (VC) between 0.5-2% by weight to form the solid electrolyte interphase (SEI) on the silicon-rich anode;
trimethylsilyl (TMSi) between 0.25-1% by weight to form the cathode-electrolyte interphase (CEI) on the nickel-rich cathode;
bis(2,2,2-trifluoroethyl) carbonate (DFDEC) between 0.5-2% by weight to form the solid electrolyte interphase (SEI) on the silicon-rich anode; and
succinic anhydride (SA) between 0.25-1% by weight to form a cathode-electrolyte interphase (CEI) on the nickel-rich cathode.

19. The battery cell in claim 18, wherein the battery cell is at least one of a prismatic cell, a pouch cell, or a cylindrical cell.

20. A vehicle having a vehicle battery, comprising:
a vehicle battery pack including a plurality of battery cells, wherein each battery cell includes
a nickel-rich cathode;
a silicon-rich anode; and
an electrolyte to provide a medium between the nickel-rich cathode and the silicon-rich anode through which lithium ions travel, the electrolyte including
a ternary salt including
lithium hexafluorophosphate (LiPF₆) having a concentration between 0.5-1.2 molar (M) to provide lithium conductivity;
lithium bis(fluorosulfonyl)imide (LiFSI) having a concentration between 0.1-0.3 molar (M) to provide lithium conductivity; and
lithium difluoro(oxalate)borate (LiDFOB) having a concentration between 0.1-0.3 molar (M) to form a cathode-electrolyte interphase (CEI) on the nickel-rich cathode;
dual-cyclic solvents including
ethylene carbonate (EC) between 0-30% by volume to form a solid electrolyte interphase (SEI) on the silicon-rich anode; and
fluoroethylene carbonate (FEC) between 0-30% by volume to form the solid electrolyte interphase (SEI) on the silicon-rich anode;
a linear carbonate solvent including
ethyl methyl carbonate (EMC) between 60-80% by volume to enhance solubility of the ternary salts; and
quaternary additives including
vinylene carbonate (VC) between 0.5-2% by weight to form the solid electrolyte interphase (SEI) on the silicon-rich anode;
trimethylsilyl (TMSi) between 0.25-1% by weight to form the cathode-electrolyte interphase (CEI) on the nickel-rich cathode;
bis(2,2,2-trifluoroethyl) carbonate (DFDEC) between 0.5-2% by weight to form the solid electrolyte interphase (SEI) on the silicon-rich anode; and
succinic anhydride (SA) between 0.25-1% by weight to form a cathode-electrolyte interphase (CEI) on the nickel-rich cathode.
